(19) United States
(12) Patent Application Publication
(10) Pub. No.: US 2008/0289744 A1
(43) Pub. Date: Nov. 27, 2008

(54) Manufacturing Method Of Pneumatic Tire

(75) Inventor: Masahiro Segawa, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/123,567

(22) Filed: May 20, 2008

(30) Foreign Application Priority Data
May 24, 2007 (JP) 2007-137604

(51) Int. Cl. B29D 30/08

(52) U.S. Cl. 156/125

(57) ABSTRACT

An annular side wall rubber is injection molded, a forming mold is mold released while retaining the side wall rubber in an unvulcanized state, and a side surface of the side wall rubber is exposed annularly. Further, a lower mold of the forming mold is moved close to a carcass body in which a center portion is evaginated to an outer side in a diametrical direction, on a forming drum, and the side surface of the side wall rubber is attached to a side portion of the carcass body. Thereafter, the side wall rubber is released from the forming mold by moving the lower mold away from the carcass body.

### BACKGROUND OF THE INVENTION

1. Technical Field

The present invention relates to a manufacturing method of a pneumatic tire provided with a step of forming an unvulcanized tire by attaching a rubber member to a carcass body having a bead portion.

2. Background Art

A description will be simply given of one example of a conventional tire forming step with reference to FIG. 6. First, as shown in FIG. 6(a), an inner liner rubber 45, a side wall rubber 41, a carcass ply 44 and the like are wound around a forming drum 47 so as to be formed as a cylindrical shape, and an annular bead 42 and a bead filler 43 are outward inserted to both sides in a width direction of the carcass ply 44. Further, a cylindrical tread member 46 obtained by integrating a tread rubber and a belt is arranged in an outer peripheral side of a center portion of the carcass ply 44. The tread member 46 is manufactured in the other step, and is supported by a transfer ring (not shown).

Next, as shown in FIG. 6(b), the center portion of the carcass ply 44 is deformed in an evaginating manner while shifting a pair of beads 42 so as to come close to each other, and an outer peripheral surface thereof is pressure attached to an inner peripheral surface of the tread member 46. Further, an end portion of the carcass ply 44 is wound via the bead 42, and a carcass body having the bead portion is formed. Further, the sidewall rubber 41 is also wound up together with the end portion of the carcass ply 44, and an unvulcanized tire is formed by attaching the side wall rubber 41 to the carcass body. The evaginating deformation of the carcass ply 44 and the wind-up of the end portion as mentioned above can be achieved by using a known expanding mechanism such as an expand able rigid core, a bladder or the like.

In the tire forming step as mentioned above, for example, if the side wall rubber is obtained by cutting an extrusion molding product at a predetermined length, there is a problem that a joint portion becomes locally thick on the basis of an overlapping or a close attaching between the end portions at a time of being formed as a cylindrical shape, thereby lowering a uniformity of a tire. Further, there is a problem that a shape of the side wall rubber is not stabilized because the side wall rubber is pressed by the bladder at a time of winding up or a circumferential length of the side wall rubber is increased.

On the contrary, there can be considered to utilize a so-called ribbon winding construction method, for example, as disclosed in the following Japanese Unexamined Patent Publication No. 2004-338626. That is, the rubber member such as the side wall rubber or the like is formed by spirally winding the narrow rubber ribbon around a side portion of the carcass body in which the center portion is evaginated. However, in accordance with this method, a forming time is elongated because a winding man hour of the rubber ribbon is increased, and there is a problem that a crack tends to be generated along an interface of the wound rubber ribbon.

Further, as disclosed in the following Japanese Unexamined Patent Publication No. 2006-248037, there can be considered to utilize an injection molding method. The patent document describes a method of forming an annular bead filler or a side wall rubber by injection pouring an unvulcanized rubber composition material into a cavity of a forming mold, and releasing the bead filler or the side wall rubber from the forming mold by using a coating member (a tray). The rubber member obtained by the method mentioned above is excellent in a shape uniformity, and a forming time can be shortened in comparison with the extrusion molding method and the ribbon winding method, by attaching the rubber member to the carcass body in which the center portion is evaginated. However, since the annular rubber member which is not vulcanized and has a low rigidity is handled, it takes a long time to precisely position and attach, it is not sufficient in the light of securing the forming precision of the tire and shortening the forming time, and there is room for further improving these points.

### SUMMARY OF THE INVENTION

The present invention is made by taking the actual condition mentioned above into consideration, and an object of the present invention is to provide a manufacturing method of a pneumatic tire which can shorten a forming time so as to improve a production efficiency while securing a forming precision of a tire.

The object can be achieved by the following present invention. That is, the present invention provides a manufacturing method of a pneumatic tire comprising:

a step of setting an annular bead in both sides in a width direction of a cylindrical carcass ply and winding up an end portion of the carcass ply via the bead so as to form a carcass body having a bead portion; and

a step of attaching a rubber member to the carcass body so as to form an unvulcanized tire,

wherein the method comprising:

a first step of forming an annular rubber member by injection pouring an unvulcanized rubber composition material into a cavity of a forming mold, mold releasing the forming mold while retaining the rubber member in an unvulcanized state, and exposing a side surface of the rubber member annularly;

a second step of attaching the exposed side surface of the rubber member to the side portion of the carcass body by moving the mold portion of the forming mold retaining the rubber member close to the carcass body in which a center portion is evaginated to an outer side in a diametrical direction; and

a third step of releasing the rubber member from the forming mold by moving the mold portion away from the carcass body, after the second step.

The present invention is to form the unvulcanized tire (green tire) by forming the annular rubber member in accordance with the first step as mentioned above, and attaching the annular rubber member to the carcass body in accordance with the second step as mentioned above. In accordance with the conventional manufacturing method, the injection molded rubber member is completely released from the forming mold, and is fed to the manufacturing line so as to be attached to the carcass body. On the contrary, in accordance with the present invention, since the rubber member is attached by moving the mold portion of the forming mold close to the carcass body in which the center portion is evaginated, it is possible to precisely and accurately position and attach the annular rubber member which is not vulcanized and has the low rigidity, and it is possible to shorten the forming time while securing the forming precision of the tire. Since the rubber member is released from the forming mold by moving the mold portion of the forming mold away from the carcass body, and has been already attached to the carcass body, the rubber member is prevented from getting out of shape.

Further, in the present invention, since the annular rubber member is obtained by the injection molding, an excellent shape uniformity can be obtained, and a uniformity of the tire can be well secured. Further, since the rubber member is retained in the unvulcanized state, an adhesive property of the rubber member with respect to the carcass ply or the like is improved, an over vulcanization is not generated at a time of vulcanizing the tire. In this case, “unvulcanized state” indicates a state in which the vulcanization is not carried out, however, is not limited to a state in which the vulcanizing reaction does not make progress at all, but includes a semi-vulcanized state and a state corresponding to an under-vulcanization (a vulcanized state which does not reach an optimum vulcanization) defined by JISK6200.

In the present invention, it is preferable to attach the rubber member while deforming the carcass body in an evaginating manner, in the second step. Accordingly, it is possible to press an exposed side surface of the rubber member to a side portion of the carcass body, by utilizing an evaginating force of the carcass body, and it is possible to easily and suitably attach the rubber member.

The present invention is particularly useful in the case that the rubber member constitutes a side wall rubber. In the case of the extrusion molding method as mentioned above, a circumferential length difference at a time of winding up is large and a shape change is great in the side wall rubber. On the contrary, in accordance with the present invention, the forming precision of the tire can be secured as mentioned above. Further, in the case of the ribbon winding construction method as mentioned above, the winding time of the rubber ribbon becomes particularly long in the side wall rubber constructing the side wall portion. On the contrary, in accordance with the present invention, it is possible to shorten the forming time of the tire as mentioned above, and it is possible to improve a production efficiency.

### BRIEF DESCRIPTION OF THE DRAWINGS

FIG. 1 is a half cross sectional view of a tire meridian line showing one example of a pneumatic tire manufactured by the present invention;

FIG. 2 is a cross sectional view schematically showing a forming mold for forming a side wall rubber;

FIG. 3(a) and 3(b) are across sectional view schematically showing a state in which the side wall rubber is formed;

FIG. 4(a), 4(b) and 4(c) are a cross sectional view schematically showing a state in which an unvulcanized tire is formed;

FIG. 5(a) and 5(b) are across sectional view schematically showing a state in which the unvulcanized tire is formed; and

FIG. 6(a) and 6(b) are across-sectional view schematically showing one example of a conventional tire forming step.

### DETAILED DESCRIPTION OF THE PREFERRED EMBODIMENTS

An embodiment of the present invention will be explained with reference to the drawings.

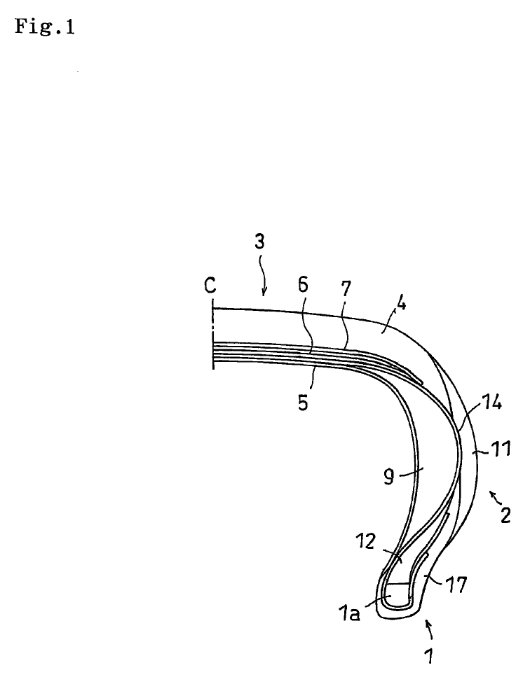

FIG. 1 is a half cross sectional view of a tire meridian line showing one example of a pneumatic tire manufactured by the present invention. The pneumatic tire comprises a pair of bead portions 1, sidewall portions 2 extending from respective bead portions 1 radially outward of the tire, and a tread portion 3 provided between the sidewall portions 2. In the bead portion 1, there are arranged an annular bead 1a constituted by a convergence body of a steel wire or the like, and a bead filler 12 formed as a triangular cross sectional shape in an outer side in a tire diametrical direction of the bead 1a, and an end portion of a carcass ply 14 is wound up to an outer side in such a manner as to pinch them.

An inner liner rubber 5 for retaining a pneumatic pressure is arranged in an inner peripheral side of the carcass ply 14. Further, a rim strip rubber 17 is arranged in an outer periphery of the bead portion 1 of the carcass ply 14, and a side wall rubber 11 is arranged in an outer side of the side wall portion 2 of the carcass ply 14. Further, a belt 6 and a belt reinforcing member 7 for reinforcing on the basis of a hoop effect are arranged in an outer peripheral side of the tread portion 3 of the carcass ply 14, and a tread rubber 4 is arranged further in an outer peripheral side thereof. The carcass ply 14 is constituted by a ply cord extending approximately at an angle of 90 degree with respect to a tire equator C. Steel and an organic fiber such as a polyester, a rayon, a nylon, an aramid or the like can use for the ply cord.

The pneumatic tire is a run-flat tire which can travel even in the case that an internal pressure is lowered by a puncture or the like, and a reinforcing rubber pad 9 having a crescent cross sectional shape is arranged in an inner side of the side wall portion 2 of the carcass ply 14. The reinforcing rubber pad 9 has a function of supporting the tire having a lowered internal pressure so as to prevent the tire from being completely flattened, and is constructed, for example, by a rubber member having a rubber hardness between 65 and 90 degree obtained by measuring on the basis of a type A durometer hardness test of JISK6253. The pneumatic tire manufactured by the present invention is not limited to the run-flat tire.

The pneumatic tire can be obtained by forming an unvulcanized tire by attaching a plurality of rubber members and vulcanizing the unvulcanized tire, however, the rubber member includes a rubber member which is formed as an annular shape or a cylindrical shape on a forming drum online, and a rubber member which is previously formed as an annular offline and is fed to the forming drum at a necessary timing. In the present embodiment, a description will be given of an example that the unvulcanized tire is formed by manufacturing the annular side wall rubber 11 offline and attaching the annular side wall rubber 11 to the carcass body.

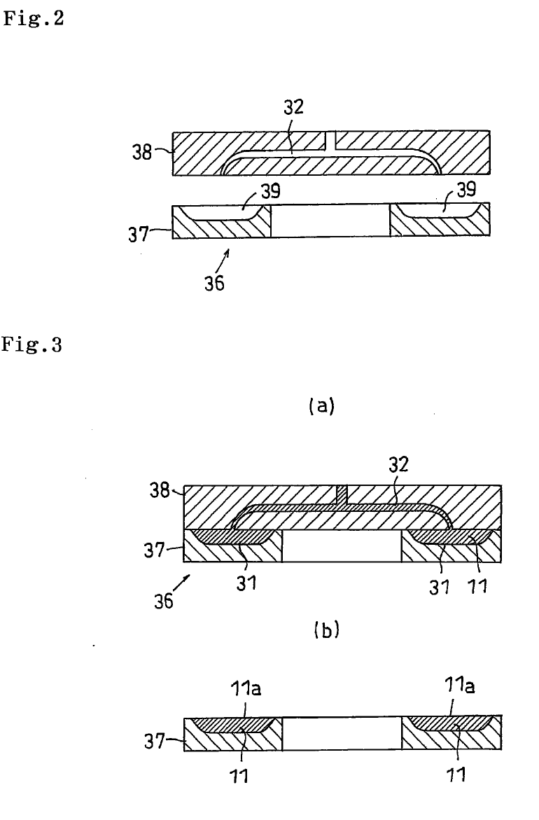

FIG. 2 is a cross sectional view schematically showing a forming mold for forming the side wall rubber. A forming mold 36 is provided with a ring-shaped lower mold 37 in which an annular concave groove 39 is formed in an upper surface, and an upper mold 38 which is arranged in an upper side of the lower mold 37, and an inner diameter of the lower mold 37 is set to be equal to or more than an outer diameter of a forming drum 21 mentioned below. Further, the forming mold 36 is structured such as to be openable and closeable by relatively moving up and down the lower mold 37 with respect to the upper mold 38, and a cavity 31 (refer to FIG. 3) having a shape corresponding to the side wall rubber 11 is formed in an interface between the molds 37 and 38 at a time of mold clamping.

In the upper mold 38, there is formed a feed path 32 constituted by a sprue extending toward a lower side from a center of the upper surface, a runner extending so as to branch into both sides in a width direction from the sprue, and a gate extending from an end portion of the runner while making a cross sectional area small. The upper mold 38 is structured such that an unvulcanized rubber composition material can be injection poured to the cavity 31 from an injection mechanism (not shown). Further, a temperature control mechanism (not shown) is provided in the forming mold 36, and is structured such as to control a temperature, a temperature control timing and the like.

FIG. 3 is a cross sectional view schematically showing a state in which the side wall rubber is formed. In the present embodiment, the annular sidewall rubber 11 is formed by injection pouring the unvulcanized rubber composition material to the cavity 31 after mold clamping the forming mold 36 as shown in FIG. 3(a), the forming mold 36 is subsequently mold released while retaining the formed side wall rubber in the unvulcanized state, and the side surface 11a of the side wall rubber 11 is exposed annularly as shown in FIG. 3(b) (corresponding to the first step). The exposed side surface 11a corresponds to a side surface which is attached to a carcass body 25 mentioned below.

In the description mentioned above, the forming mold 36 at a time of injection pouring the unvulcanized rubber composition material is heated and retained at such a degree of temperature as to secure a fluidity of the unvulcanized rubber composition material. The temperature may be lower than a vulcanizing temperature, or may be set to the vulcanizing temperature in the same manner as the conventional injection molding. The forming mold 36 is mold released while the side wall rubber 11 is in the unvulcanized state, and the forming mold 36 may be cooled as occasion demands in such a manner as to prevent the vulcanization from making progress.

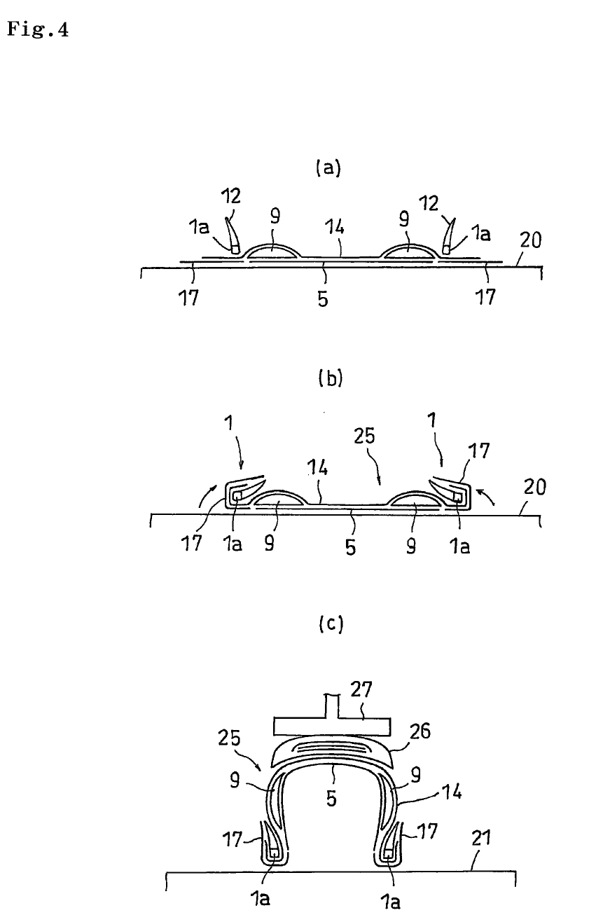

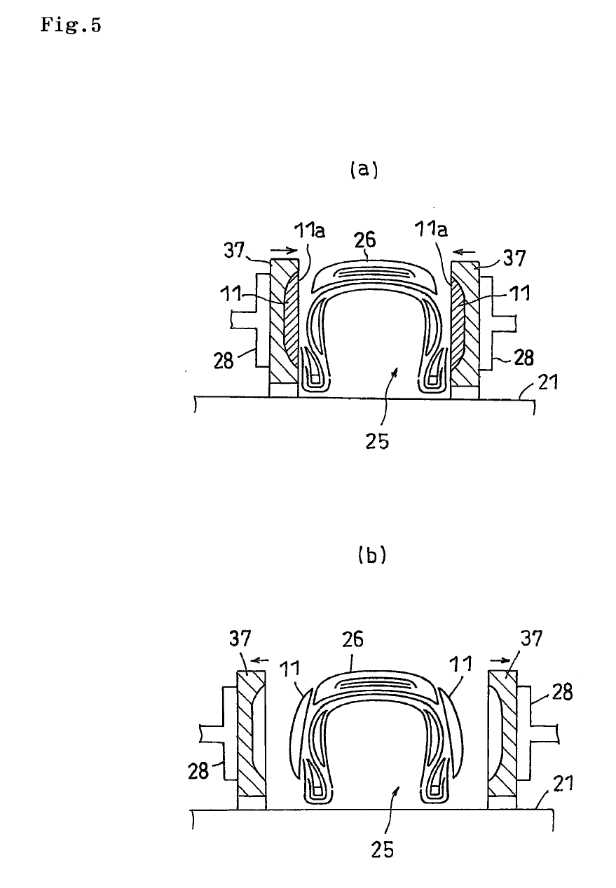

FIGS. 4 and 5 are cross sectional views schematically showing a state in which the unvulcanized tire is formed by attaching a plurality of rubber members including the side wall rubber 11 formed as mentioned above.

First, as shown in FIG. 4(a), the inner liner rubber 5 and the rim strip rubber 17 are wound around the outer peripheral surface of the forming drum 20, and each of them is formed as a cylindrical shape in a state in which the end portions of both the rubbers are pressure attached to each other. Subsequently, a pair of reinforcing rubber pads 9 is arranged at predetermined positions so as to be formed as a cylindrical shape, and the carcass ply 14 is further wound around the outer peripheral side of the reinforcing rubber pads 9 so as to be formed as a cylindrical shape. Further, the bead 1a and the bead filler 12 which are previously formed as the annular shape offline are outward inserted to a predetermined position.

Next, as shown in FIG. 4(b), the end portion of the carcass ply 14 and the rim strip rubber 17 are wound up via the bead 1a. After winding up, the rubber members may be pressure attached to each other by a stitching machine or the like as occasion demands. The bead 1a and the bead filler 12 are pinched by winding up the end portion of the carcass ply 14, and the carcass body 25 having a pair of bead portions 1 is formed. The wind-up motion mentioned above can be carried out by a bladder (not shown) which is arranged near the end portion of the carcass body 25 in the outer circumferential portion of the forming drum 20.

Next, the carcass body 25 is transferred to the forming drum 21, and the center portion of the carcass body 25 is deformed in the evaginating manner to the outer side in the diametrical direction while shifting a pair of beads 1a close to each other, as shown in FIG. 4(c). The evaginating deformation of the carcass body 25 can be achieved by an expanding mechanism (not shown) such as an expand able rigid core, a bladder or the like arranged in the inner peripheral side of the center portion of the carcass ply 14 while fixing the bead 1a by a known bead lock mechanism (not shown) and shifting so as to come close to each other. In the present embodiment, there is shown the embodiment in which the carcass body 25 formed by the forming drum 20 is transferred to the forming drum 21 provided with the bead lock mechanism and the expanding mechanism so as to form, however, the present invention is not limited to this, but it is possible to form on one forming drum.

Further, the center portion of the carcass body 25 is attached to the inner peripheral surface of the cylindrical tread member 26 arranged in the outer circumferential side of the carcass body 25 by evaginating and deforming the center portion of the carcass body 25 to the outer side in the diametrical direction. The tread member 26 corresponds to a member which is manufactured by integrating the tread rubber 4, the belt 6 and the belt reinforcing member 7 in the other step, and is supported and carried by a transfer ring 27. The transfer ring 27 is detached from the tread member 26 at an appropriate timing after attaching the tread member 26 to the carcass body 25.

Subsequently, the unvulcanized tire is formed by attaching the offline manufactured side wall rubber 11 to the side portion of the carcass body 25. Specifically, as shown in FIG. 5(a), the lower mold 37 (corresponding to the mold portion of the forming mold retaining the rubber member) retaining the side wall rubber 11 is moved close to the carcass body 25 in which the center portion is evaginated and deformed, from both sides, and the side surface 11a of the side wall rubber 11 is attached to the side portion of the carcass body 25 (corresponding to the second step). Accordingly, it is possible to precisely, accurately and easily position and attach the side wall rubber 11 which is not vulcanized and has the low rigidity, and it is possible to shorten the forming time while securing the forming precision of the tire.

A transfer ring 28 is attached to a bottom surface of the lower mold 37, and the lower mold 37 is retained in a standup posture which is rotated at 90 degree from a state shown in FIG. 3(b). The transfer ring 28 is structured such as to be movable in a drum axial direction of the forming drum 21, the lower mold 37 in the standup posture can be outward inserted to the forming drum 21 at a predetermined diametrical position, and the side surface 11a of the side wall rubber 11 can be further made close to the carcass body 25.

Since the side wall rubber 11 in the unvulcanized state has a high adhesive property and is closely attached to the annular concave groove 39 of the lower mold 37, the side wall rubber 11 does not fall away from the lower mold 37 even in this standup posture. In this case, in order to more securely prevent the side wall rubber 11 from falling away, a suction cup effect may be increased by making a surface roughness of the annular concave groove 39 small, or the side wall rubber 11 may be sucked and retained through a suction hole communicated with the bottom surface of the annular concave groove 39.

It is preferable to attach the side wall rubber 11 to the carcass body 25 while evaginating and deforming the carcass body 25. Accordingly, it is possible to press the side surface 11a of the side wall rubber 11 to the side portion of the carcass body 25 by utilizing an evaginating force of the carcass body 25, and it is possible to easily and suitably attach the side wall rubber 11. In this case, the side wall rubber 11 may be attached to the carcass body 25 which is finished being evaginated and deformed, however, since the side portion of the carcass body 25 is deflected to the inner side at a time of pressing the side wall rubber 11, there is a case that a workability is lowered.

The attaching work as mentioned above can be achieved by previously moving the lower mold 37 close to the position at which the side portion of the carcass body 25 is arranged, and the side portion is pressed against the side surface 11a of the side wall rubber 11 on the basis of the evaginating deformation of the carcass body 25. Alternatively, the side wall rubber 11 may be attached by temporarily stopping the evaginating deformation of the carcass body 25 at a time when the tread member 26 is attached, moving the lower mold 37 close to the side portion of the carcass body 25 and thereafter restarting the evaginating deformation of the carcass body 25.

After attaching the side wall rubber 11, the lower mold 37 is moved away from the carcass body 25 as shown in FIG. 5(b), thereby releasing the side wall rubber 11 from the lower mold 37 (corresponding to the third step mentioned above). Since the side wall rubber 11 is more strongly adhered to the carcass body 25 corresponding to the rubber member than the lower mold 37, the side wall rubber 11 can be smoothly mold released only by moving the lower mold 37 away as mentioned above. Further, since the side wall rubber 11 has been already attached to the carcass body 25, the sidewall rubber 11 is prevented from getting out of shape. In this case, an air may be injected out from an injection hole communicated with the bottom surface of the annular concave groove 39 at a time of moving the lower mold 37 away, thereby increasing a releasing performance of the side wall rubber 11.

Since the side wall rubber 11 is obtained in accordance with an injection molding, the side wall rubber 11 is excellent in a shape uniformity. Further, since the side wall rubber 11 is precisely positioned with respect to the carcass body 25, it is possible to well secure the uniformity of the tire. Since the side wall rubber 11 is retained in the unvulcanized state, the side wall rubber 11 has a good adhesive property with respect to the carcass body 25, and an over vulcanization is not generated at a time of vulcanizing the tire.

The manufacturing method of the pneumatic tire in accordance with the present invention is the same as the conventional method except the point that the rubber member (the side wall rubber 11 in the embodiment mentioned above) is attached as mentioned above at a time of forming the unvulcanized tire, and it is possible to appropriately employ the known tire forming step.

### OTHER EMBODIMENT

(1) The structure of the pneumatic tire manufactured in accordance with the present invention is not limited to the structure shown in FIG. 1, and the material and the shape thereof are not particularly limited. In the embodiment mentioned above, there is shown the example of the tire having the side on tread structure, however, the present invention is not limited to this, but the present invention can be applied to a tire having a tread on side structure in which the end portion of the tread rubber is laminated on the end portion of the side wall rubber. In this case, the tread member may be attached by attaching the side wall rubber in the process of evaginating and deforming the carcass body and thereafter evaginating the carcass body further.

(2) In the embodiment mentioned above, there is shown the example in which the lower mold 37 retaining the side wall rubber 11 is supported and carried by the transfer ring 28, however, the present invention is not limited to this. For example, the forming drum 21 may be provided with a slide mechanism which supports the lower mold 37 and is movable in the drum axial direction, whereby the side wall rubber 11 may be attached.

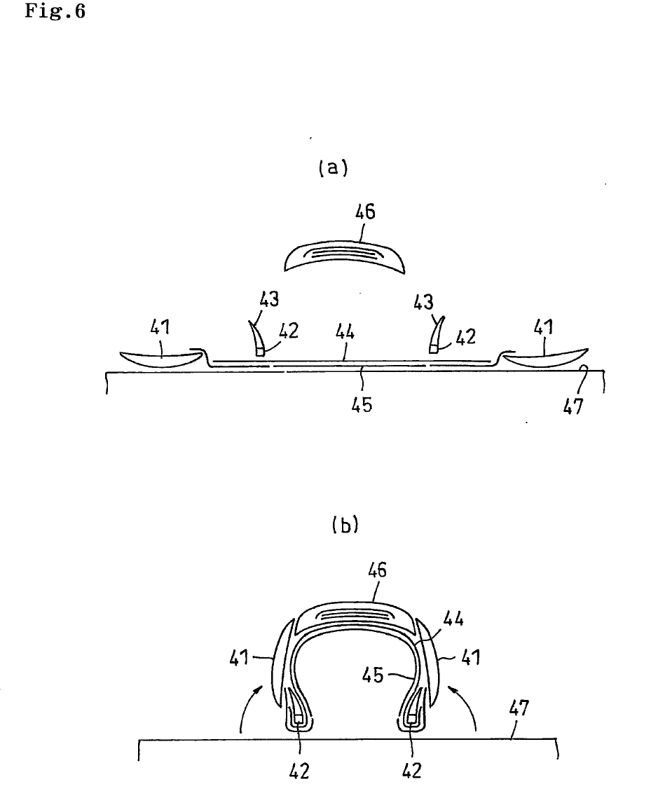

(3) In the embodiment mentioned above, there is shown the example which carries out the step of winding up the end portion of the carcass ply, and the step of evaginating and deforming the center portion of the carcass ply step by step, however, these steps may be carried out in a lump as exemplified in FIG. 6, and the rubber member such as the side wall rubber or the like may be thereafter attached to the side portion of the carcass body.

(4) In the present invention, it is preferable to employ the side wall rubber as the rubber member attached to the carcass body as mentioned above, however, the present invention is not limited to this, but can employ without being particularly limited, as far as a rubber member is attached to the side portion of the carcass body. For example, the rubber member may be constituted by a rubber member which constructs an annular evaginating portion evaginating to the outer side in the tire width direction of the bead portion, in a double bead type pneumatic tire. Further, an annular multilayer rubber member may be formed by injection pouring the different kind of unvulcanized rubber composition material into the cavity of the forming mold, and may be attached to the carcass body as mentioned above.

What is claimed is:

1. A manufacturing method of a pneumatic tire comprising:
a step of setting an annular bead in both sides in a width direction of a cylindrical carcass ply and winding up an end portion of the carcass ply via the bead so as to form a carcass body having a bead portion; and
a step of attaching a rubber member to the carcass body so as to form an unvulcanized tire,
wherein the method comprising:
a first step of forming an annular rubber member by injection pouring an unvulcanized rubber composition material into a cavity of a forming mold, mold releasing the forming mold while retaining the rubber member in an unvulcanized state, and exposing a side surface of the rubber member annularly;
a second step of attaching the exposed side surface of the rubber member to the side portion of the carcass body by moving the mold portion of the forming mold retaining the rubber member close to the carcass body in which a center portion is evaginated to an outer side in a diametrical direction; and
a third step of releasing the rubber member from the forming mold by moving the mold portion away from the carcass body, after the second step.

2. A manufacturing method of a pneumatic tire as claimed in claim 1, wherein the rubber member is attached while evaginating and deforming the carcass body in the second step.

3. A manufacturing method of a pneumatic tire as claimed in claim 1, wherein the rubber member constitutes a side wall rubber.
